(19) United States
(12) Patent Application Publication
(10) Pub. No.: US 2007/0016951 A1
(43) Pub. Date: Jan. 18, 2007

(54) Systems and methods for identifying sources of malware

(76) Inventors: Paul L. Piccard, Longmont, CO (US); Michael P. Greene, Boulder, CO (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/180,161

(22) Filed: Jul. 13, 2005

(51) Int. Cl. G06F 12/14

(52) U.S. Cl. 726/24

(57) ABSTRACT

Systems and methods for identifying sources of malware are described. In one embodiment, a system includes a malware detection module configured to determine that a protected computer includes malware. The system also includes a history log module configured to access a history log of the protected computer to identify a set of potential sources of the malware.

### FIELD OF THE INVENTION

The invention relates generally to computer system management. In particular, but not by way of limitation, the invention relates to systems and methods for identifying sources of malware.

### BACKGROUND OF THE INVENTION

Personal computers and business computers can be vulnerable to attack by computer programs such as keyloggers, system monitors, browser hijackers, dialers, Trojans, spyware, and adware, which are collectively referred to as “malware” or “pestware.” Malware typically operates to collect information about a person or an organization—often without the person's or the organization's knowledge. In some instances, malware also operates to report information that is collected about a person or an organization. Some malware is highly malicious. Other malware is non-malicious but may nevertheless raise concerns with privacy or computer system performance. And yet other malware is actually desired by a user.

Techniques are currently available to detect and remove malware. But as malware evolves, techniques for detecting and removing malware should also evolve. Current techniques for detecting and removing malware are not always satisfactory and will likely not be satisfactory in the future. In particular, current techniques for detecting and removing malware often use definitions of known malware to scan files of a protected computer. However, it is often difficult to initially locate malware in order to generate definitions, particularly since malware can evolve. It would be desirable to identify sources of malware, such that definitions can be rapidly generated or updated to account for new or evolving malware. In addition, identification of sources of malware would allow a blacklist of those sources to be generated.

Current techniques for identifying sources of malware sometimes involve manually surfing the Internet to identify Web sites that distribute malware. Such techniques can be inefficient for a number of reasons. In particular, certain inefficiencies of such techniques follow from its manual nature. In addition, surfing the Internet can be a somewhat haphazard process. As a result, Web sites that do not, in fact, distribute malware may be targeted for evaluation, while Web sites that, in fact, distribute malware may be overlooked. Accordingly, systems and methods are needed to address the shortfalls of current techniques and to provide other new and innovative features.

### SUMMARY OF THE INVENTION

Embodiments of the invention include systems of managing malware. In one embodiment, a system includes a malware detection module configured to determine that a protected computer includes malware. The system also includes a history log module configured to access a history log of the protected computer to identify a set of potential sources of the malware.

Embodiments of the invention also include computer-readable media. In one embodiment, a computer-readable medium includes executable instructions to detect a presence of malware that is downloaded using a Web browser. The computer-readable medium also includes executable instructions to access the Web browser's history log to identify a set of Web sites. The computer-readable medium further includes executable instructions to report that the set of Web sites include a potential malware distribution site.

Embodiments of the invention further include computer-implemented methods of managing malware. In one embodiment, a computer-implemented method includes detecting malware on a protected computer. The computer-implemented method also includes collecting information from a history log of the protected computer. The computer-implemented method further includes directing the protected computer to convey the information to a host computer, such that the information can be used to identify a source of the malware.

Other embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a computer system that is implemented in accordance with an embodiment of the invention.

FIG. 2 illustrates a flowchart for identifying a malware distribution site, according to an embodiment of the invention.

### DETAILED DESCRIPTION

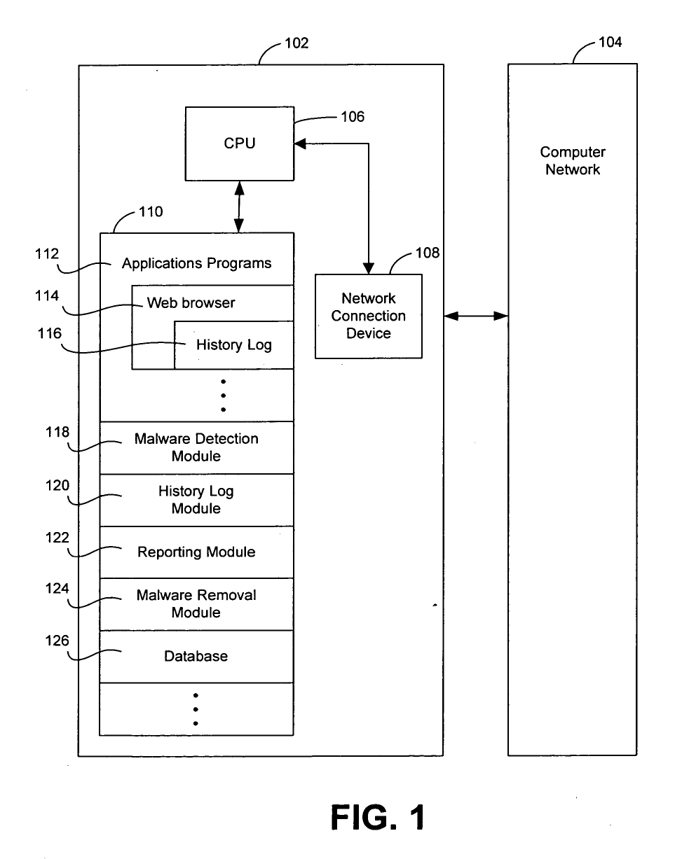

FIG. 1 illustrates a computer system 100 that is implemented in accordance with an embodiment of the invention. The computer system 100 includes at least one protected computer 102, which is connected to a computer network 104 via any wire or wireless transmission channel. In general, the protected computer 102 can be a client computer, a server computer, or any other device with data processing capability. Thus, for example, the protected computer 102 can be a desktop computer, a laptop computer, a handheld computer, a tablet computer, a personal digital assistant, a cellular telephone, a firewall, or a Web server. In the illustrated embodiment, the protected computer 102 is a client computer and includes conventional client computer components, including a Central Processing Unit (“CPU”) 106 that is connected to a network connection device 108 and a memory 110.

As illustrated in FIG. 1, the memory 110 stores a number of computer programs, including a set of application programs 112. The application programs 112 operate to perform various types of user-oriented operations. Referring to FIG. 1, the application programs 112 include a Web browser 114, which operates to establish communications with the computer network 104 via the network connection device 108. In particular, the Web browser 114 is operated by a user who visits various Web sites that are included in the computer network 104. For example, the user can access and download various files from those Web sites, which files can include Web pages, data files, text files, documents, spreadsheets, image files, audio files, Musical Instrument Digital Interface (“MIDI”) files, video files, multimedia files, batch files, and files including computer programs. While not illustrated in FIG. 1, it is contemplated that other types of application programs can be included, such as an electronic-mail (“e-mail”) program, a word processing program, a spreadsheet program, a database management program, a file transfer program, a desktop publishing program, a drawing program, a graphics program, an image editing program, and a media player.

In the illustrated embodiment, each of the application programs 112 maintains a separate history log, which serves to provide a record of events related to operation of that application program. In particular, when an event occurs during operation of an application program, an entry that is indicative of that event is recorded in that application program's history log. Referring to FIG. 1, the Web browser 114 maintains a history log 116, which serves to provide a record of Web browsing events. In particular, when a user visits a Web site, the Web browser 114 records an entry that is indicative of that Web site in the history log 116. For example, when a file is accessed and downloaded from a Web site, the Web browser 114 can record a Web address of the file in the history log 116. A Web address typically specifies a location of a file within a Web site. For example, a Web address can be a Uniform Resource Identifier (“URI”) of a file, such as a Uniform Resource Locator (“URL”) of the file. It is also contemplated that a Web address can be defined in various other ways, such as using an Internet Protocol (“IP”) address or any other identifier of a source of a file. While not illustrated in FIG. 1, it is contemplated that additional history logs can be maintained to provide a record of other types of events, such as events related to operation of an e-mail program, a word processing program, or a database management program. It is also contemplated that the application programs 112 can maintain a common history log to provide a record of events for all of the application programs 112.

As illustrated in FIG. 1, the memory 110 also stores a set of computer programs that implement the operations described herein. In particular, the memory 110 stores a malware detection module 118, a history log module 120, a reporting module 122, and a malware removal module 124. As further described below, the various modules 118, 120, 122, and 124 operate to manage malware that can be present in the computer system 100. Referring to FIG. 1, the various modules 118, 120, 122, and 124 operate in conjunction with a database 126, which includes information related to malware. In particular, the database 126 includes a set of malware definitions to allow for detection of malware. As illustrated in FIG. 1, the database 126 also includes a blacklist of sources of malware. For example, the blacklist of sources of malware can include a list of malware distribution sites to alert a user about those Web sites that are known to distribute malware or that are suspected of distributing malware. The database 126 can be implemented as, for example, a relational database in which information is organized using a set of tables.

In the illustrated embodiment, the malware detection module 118, the history log module 120, and the reporting module 122 operate to facilitate identification of sources of malware. In particular, the malware detection module 118 monitors the protected computer 102 on a periodic or some other basis to determine whether the protected computer 102 includes malware. For example, the malware detection module 118 can analyze files that are downloaded using the Web browser 114 to determine whether those files include malware. Detection of malware on the protected computer 102 can be based on, for example, the set of malware definitions that are included in the database 126.

If the malware detection module 118 determines that the protected computer 102 includes malware, the history log module 120 collects information from one or more history logs maintained by the application programs 112. Desirably, this information includes the n most recently recorded entries in a particular history log, where n is an integer that is at least one. By appropriately setting n with respect to the frequency at which the malware detection module 118 monitors the protected computer 102, the information that is collected by the history log module 120 will include or will likely include at least one recorded entry that is indicative of a source of the malware. For example, if the malware is downloaded using the Web browser 114, the history log module 120 can access the history log 116 to identify the n most recently visited Web sites. In such manner, the history log module 120 can identify those Web sites from which the malware may have been downloaded and, thus, can identify those Web sites as potential or suspected malware distribution sites. To facilitate targeted collection of information, the history log module 120 can identify which one of the application programs 112 was used to access or download the malware, and the history log module 120 can then collect information from that application program's history log. Identification of which one of the application programs 112 was used to access or download the malware can be based on, for example, characteristics of the malware. It is also contemplated that the history log module 120 can collect information from one or more predetermined history logs, such as the history log 116.

Once the history log module 120 collects the information from one or more history logs, the reporting module 122 then reports this information to a remotely-located host computer that is included in the computer network 104. For example, the reporting module 122 can direct the protected computer 102 to convey this information to the host computer via the network connection device 108. This information as well as any additional relevant information can be analyzed at the host computer to identify a source of the malware. For example, the reporting module 122 can report the n most recently visited Web sites to the host computer, and the host computer or a user at the host computer can evaluate those Web sites to determine whether any of those Web sites is, in fact, a malware distribution site.

As illustrated in FIG. 1, the malware removal module 124 operates to remove the malware on the protected computer 102. In particular, once the malware detection module 118 determines that the protected computer 102 includes the malware, the malware removal module 124 removes the malware from the protected computer 102. It is also contemplated that the malware removal module 124 can quarantine the malware pending confirmation of whether the malware is, in fact, malicious or undesired by a user.

Advantageously, the illustrated embodiment improves the efficiency at which sources of malware can be identified. In particular, since the computer system 100 can include additional protected computers that are implemented in a similar fashion as the protected computer 102, certain efficiencies of the illustrated embodiment follow from its decentralized nature. In addition, the illustrated embodiment allows automated collection and reporting of relevant information once malware is detected on the protected computer 102. Furthermore, the illustrated embodiment allows targeted evaluation of Web sites that are being visited by users and that may be distributing malware. As a result, Web sites that do not distribute malware can be omitted from evaluation, while Web sites that distribute malware or are suspected of distributing malware can be targeted for evaluation.

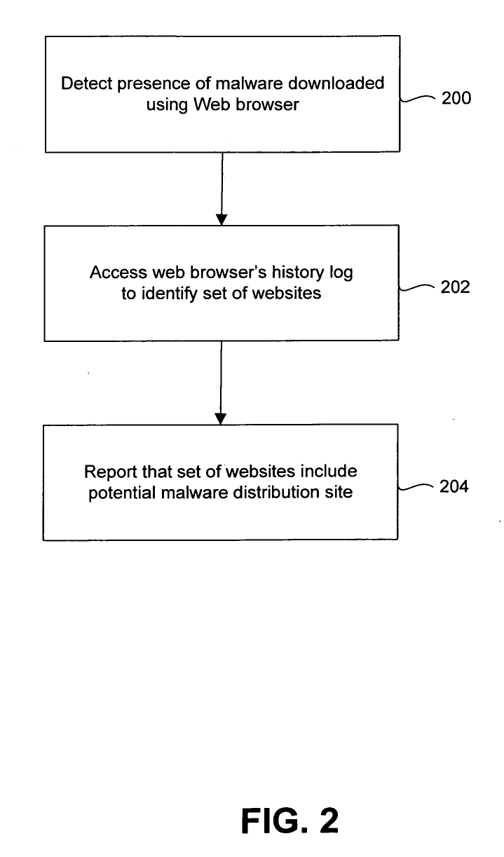

The foregoing provides a general overview of an embodiment of the invention. Attention next turns to FIG. 2, which illustrates a flowchart for identifying a malware distribution site, according to an embodiment of the invention.

The first operation illustrated in FIG. 2 is to detect a presence of malware that is downloaded using a Web browser (e.g., the Web browser 114) (block 200). In the illustrated embodiment, a malware detection module (e.g., the malware detection module 118) detects the presence of the malware on a protected computer (e.g., the protected computer 102) by monitoring the protected computer on a periodic or some other basis. It is also contemplated that operation of the malware detection module can be triggered based on a particular event, such as a Web browsing event. For example, once a file is downloaded using the Web browser, the malware detection module can analyze the file to detect the malware in the file.

In the illustrated embodiment, the malware detection module detects the presence of the malware on the protected computer based on a set of malware definitions. In particular, the set of malware definitions can include representations of known malware, and the malware detection module can scan files of the protected computer to detect the malware in one of the files. For example, the set of malware definitions can include a hash value or a digital signature of known malware, such as one that is generated using Message Digest 5 (“MD5”). In this example, the malware detection module can generate a hash value of a particular file to be analyzed, and can compare the hash value of that file with a set of hash values of known malware to determine whether there is a sufficient match. As another example, the set of malware definitions can include a Cyclical Redundancy Code (“CRC”) of a portion of known malware. In this example, the malware detection module can generate a CRC of a particular file to be analyzed, and can compare the CRC of that file with a set of CRCs of known malware to determine whether there is a sufficient match.

Alternatively, or in conjunction, the set of malware definitions can include suspicious activities that are indicative of or that are common to known malware, and the malware detection module can monitor activities of the protected computer to detect the presence of the malware on the protected computer. For example, the set of malware definitions can include suspicious activities related to third-party cookies or related to entries or modifications of registry files of an operating system.

The second operation illustrated in FIG. 2 is to access the Web browser's history log (e.g., the history log 116) to identify a set of Web sites (block 202). In the illustrated embodiment, once the malware detection module detects the presence of the malware on the protected computer, a history log module (e.g., the history log module 120) accesses the Web browser's history log to identify the n most recently visited Web sites. By appropriately setting n with respect to the frequency at which the malware detection module monitors the protected computer, the n most recently visited Web sites will include or will likely include a Web site from which the malware was downloaded. For example, n can be set to have a larger magnitude if the malware detection module monitors the protected computer at a relatively less frequent basis. On the other hand, n can be set to have a smaller magnitude if the malware detection module monitors the protected computer at a relatively more frequent basis.

In the illustrated embodiment, the history log module accesses the Web browser's history log to identify a set of Web addresses associated with the set of Web sites. In particular, the history log module accesses the Web browser's history log to identify the n most recently recorded Web addresses in the Web browser's history log. As described previously, a Web address can be a URL of a file that is downloaded from a Web site. For example, a Web address can have the following format: http://www.DomainName.com/Subdirectory/FileName.html, where “http://” specifies a communication protocol used to download a file, “www.DomainName” specifies a domain name of a Web site from which the file was downloaded, “/Subdirectory/” specifies a subdirectory within the Web site from which the file was downloaded, and “FileName.html” specifies a name of the file. Thus, by collecting the set of Web addresses from the Web browser's history log, the history log module can facilitate identification of the set of Web sites from which the malware may have been downloaded, such as in terms of domain names of the set of Web sites.

To facilitate collection and reporting of relevant information, the history log module can generate a separate history log based on the Web browser's history log. For example, the history log module can access the Web browser's history log to extract salient information from the Web browser's history log, such as domain names of recently visited Web sites. In such manner, the history log module can accelerate and simplify collection and reporting of relevant information, which, in turn, can accelerate and simplify identification of the set of Web sites from which the malware may have been downloaded. It is also contemplated that the history log module can generate a separate history log independently of the Web browser's history log. Further acceleration and simplification can be achieved by filtering out duplicative entries, such as when the same version of a file is downloaded multiple times from the same Web site, or by filtering out entries that are associated with approved Web sites.

The third operation illustrated in FIG. 2 is to report that the set of Web sites include a potential malware distribution site (block 204). In the illustrated embodiment, once the history log module identifies the set of Web sites, a reporting module (e.g., the reporting module 122) reports information relating to the set of Web sites to a remotely-located host computer that is connected to the protected computer. This information can identify the set of Web sites as potential malware distribution sites, such as in terms of the domain names of the set of Web sites. It is also contemplated that this information can include a representation of the malware or can identify suspicious activities related to the malware. This information as well as any additional relevant information can be analyzed at the host computer to determine whether any of the set of Web sites is, in fact, a malware distribution site. If a particular one of the set of Web sites is determined to be a malware distribution site, a new or updated set of malware definitions can be generated based on content within that Web site, and the new or updated set of malware definitions can be provided to the protected computer. In addition, content within that Web site can be monitored on a periodic or some other basis for new or updated malware. Furthermore, a new or updated list of malware distribution sites can be generated so as to identify that Web site, and the new or updated list of malware distribution sites can be provided to the protected computer.

In the illustrated embodiment, the reporting module also alerts a user of the protected computer about the set of Web sites. In particular, once the history log module identifies the set of Web sites, the reporting module alerts the user that the set of Web sites include a potential malware distribution site. In addition, if the user subsequently visits a particular one of the set of Web sites or attempts to download a file from that Web site, the reporting module again alerts the user. It is also contemplated that the reporting module can alert the user about a Web site pending confirmation of whether that Web site is, in fact, a malware distribution site.

It should be recognized that the embodiments of the invention described above are provided by way of example, and various other embodiments are contemplated. For example, with reference to FIG. 1, while the various modules 118, 120, 122, and 124 and the database 126 are illustrated as included in the protected computer 102, it should be recognized that such configuration is not required in all implementations. In particular, it is contemplated that one or more of the various modules 118, 120, 122, and 124 and the database 126 can be included in a separate computer that is connected to the protected computer 102. Thus, for example, one or more of the various modules 118, 120, 122, and 124 and the database 126 can be included in the host computer that is included in the computer network 104.

As another example, while certain embodiments of the invention have been described with reference to identifying malware distribution sites, it should be recognized that other sources of malware can be identified as described herein. For example, with reference to FIG. 1, other sources of malware that can be identified include sources that are external to the protected computer 102, such as a sender of an e-mail that includes the malware or an external database from which the malware was accessed or downloaded. Further sources of malware that can be identified include sources that are internal to the protected computer 102, such as a file of the protected computer 102 that includes the malware.

An embodiment of the invention relates to a computer program product with a computer-readable medium including computer code or executable instructions thereon for performing a set of computer-implemented operations. The medium and computer code can be those specially designed and constructed for the purposes of the invention, or they can be of the kind well known and available to those having ordinary skill in the computer software arts. Examples of computer-readable media include: magnetic media such as hard disks, floppy disks, and magnetic tape; optical media such as Compact Disc-Read Only Memories (“CD-ROMs”) and holographic devices; magneto-optical media such as floptical disks; and hardware devices that are specially configured to store and execute computer code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as generated by a compiler, and files including higher-level code that are executed by a computer using an interpreter. For example, an embodiment of the invention can be implemented using Java, C++, or other object-oriented programming language and development tools. Additional examples of computer code include encrypted code and compressed code. Moreover, an embodiment of the invention can be downloaded as a computer program product, which can be transferred from a remotely-located computer to a protected computer by way of data signals embodied in a carrier wave or other propagation medium via a transmission channel. Accordingly, as used herein, a carrier wave can be regarded as a computer-readable medium.

Another embodiment of the invention can be implemented using hardwired circuitry in place of, or in combination with, computer code. For example, with reference to FIG. 1, the various modules 118, 120, 122, and 124 can be implemented using computer code, hardwired circuitry, or a combination thereof.

While the invention has been described with reference to some embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while the methods described herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A computer-implemented method of managing malware, comprising:
detecting malware on a protected computer;
collecting information from a history log of the protected computer; and
directing the protected computer to convey the information to a host computer, such that the information can be used to identify a source of the malware.

2. The computer-implemented method of claim 1, wherein the detecting the malware includes scanning files of the protected computer to detect the malware in one of the files.

3. The computer-implemented method of claim 1, wherein the detecting the malware includes monitoring the protected computer for activity that is indicative of the malware on the protected computer.

4. The computer-implemented method of claim 1, wherein the collecting the information includes identifying an application program used to access the malware and collecting the information from the application program's history log.

5. The computer-implemented method of claim 1, wherein the collecting the information includes collecting the n most recently recorded entries in the history log, and n is an integer that is at least one.

6. The computer-implemented method of claim 1, wherein the history log corresponds to a Web browser's history log, the collecting the information includes identifying the n most recently recorded Web addresses in the Web browser's history log, and n is an integer that is at least one.

7. The computer-implemented method of claim 6, wherein the information can be used to identify one of the Web addresses as being associated with the source of the malware.

8. A computer-readable medium comprising executable instructions to:
detect a presence of malware that is downloaded using a Web browser;
access the Web browser's history log to identify a set of Web sites; and
report that the set of Web sites include a potential malware distribution site.

9. The computer-readable medium of claim 8, wherein the executable instructions to detect the presence of the malware include executable instructions to detect the presence of the malware based on a set of malware definitions.

10. The computer-readable medium of claim 8, wherein the set of Web sites correspond to the n most recently visited Web sites, and n is an integer that is at least one.

11. The computer-readable medium of claim 8, wherein the executable instructions to access the Web browser's history log include executable instructions to access the Web browser's history log to identify a set of Web addresses associated with the set of Web sites.

12. The computer-readable medium of claim 11, wherein the set of Web addresses correspond to a set of Uniform Resource Locators associated with the set of Web sites.

13. A system of managing malware, comprising:
a malware detection module configured to determine that a protected computer includes malware; and
a history log module configured to access a history log of the protected computer to identify a set of potential sources of the malware.

14. The system of claim 13, wherein the history log corresponds to a Web browser's history log.

15. The system of claim 14, wherein the history log module is configured to access the Web browser's history log to identify the n most recently visited Web sites, and n is an integer that is at least one.

16. The system of claim 14, wherein the history log module is configured to access the Web browser's history log to identify the n most recently recorded Web addresses, and n is an integer that is at least one.

17. The system of claim 13, further comprising:
a reporting module configured to report the set of potential sources of the malware to a host computer.
